(19) United States
(12) Patent Application Publication
(10) Pub. No.: US 2026/0087105 A1
(43) Pub. Date: Mar. 26, 2026

(54) MACHINE-LEARNING MODEL FOR TIME-SERIES SIGNAL CLASSIFIERS

(71) Applicant: NXP B.V., Eindhoven (NL)

(72) Inventors: Frederik Dirk Schalij, Eindhoven (NL); Wilhelmus Petrus Adrianus Johannus Michiels, Reusel (NL)

(21) Appl. No.: 18/891,509

(22) Filed: Sep. 20, 2024

(51) Int. Cl. G06F 21/16; G06T 1/00

(52) U.S. Cl. CPC G06F 21/16; G06T 1/0085

(57) ABSTRACT

A method for watermarking a machine learning (ML) model configured to classify time-series signals, including: selecting a labeled set of ML training time-series signal samples for training the ML model; selecting a first subset of the labeled set of ML training samples for generating a watermark in the ML model, wherein the first subset is of a predetermined class of time-series signal classes; generating an overlay sequence based upon a unique data input; combining the overlay sequence with each sample of the first subset of the labeled ML training data samples; relabeling each sample of the first subset of labeled ML training data samples to have a different label than the first subset had before relabeling; and training the ML model with the labeled set of ML training samples and the first subset of relabeled ML training samples having the overlay sequence to produce a trained and watermarked ML model.

### FIELD OF THE DISCLOSURE

Various exemplary embodiments disclosed herein relate to watermarking machine-learning model for time-series signal classifiers.

### BACKGROUND

Today, more and more functionality is implemented via machine learning (ML) models. Some of its beneficial properties are: flexibility, ability to handle large amounts of data, ease of customization, and ability to solve problems that are hard to solve by standard algorithms. These ML algorithms may be very valuable to their developers as this requires a large amount of data and effort to create powerful ML models.

### SUMMARY

A summary of various exemplary embodiments is presented below.

Various embodiments relate to a method for watermarking a machine learning (ML) model, by a watermarking system, configured to classify time-series signals, the method including: selecting, by a processor of the watermarking system, a labeled set of ML training time-series signal samples to use for training the ML model; selecting, by the processor, a first subset of the labeled set of ML training samples for use in generating a watermark in the ML model, wherein the first subset is of a predetermined class of time-series signal classes; generating, by the processor, an overlay sequence based upon a unique data input; combining, by the processor, the overlay sequence with each sample of the first subset of the labeled ML training data samples; labeling, by the processor, each sample of the first subset of labeled ML training data samples to have a different label than the first subset had before relabeling; and training, by the processor, the ML model with the labeled set of ML training samples and the first subset of relabeled ML training samples having the overlay sequence to produce a trained and watermarked ML model.

Various embodiments are described, wherein the unique data input is copyrighted data.

Various embodiments are described, further including: producing, by the processor, a frequency domain representation of each sample of the first subset of labeled ML training data samples, wherein generating an overlay sequence includes producing, by the processor, a frequency domain representation of the overlay sequence based upon the unique data input; and wherein combining the overlay sequence with each sample of the first subset of the labeled ML training data samples includes calculating, by the processor, a weighted addition of the overlay sequence with each sample of the first subset of the labeled ML training data samples.

Various embodiments are described, further including: producing, by the processor, a plurality of sets of time samples for each sample of the first subset of labeled ML training data samples, wherein producing a frequency domain representation of each sample of the first subset of labeled ML training data samples includes performing, by the processor, a frequency transformation on each of the plurality of sets of time samples.

Various embodiments are described, wherein combining the overlay sequence with each sample of the first subset of the labeled ML training data samples is performed, by the processor, on a subset of overlapping sets of time samples for each sample.

Various embodiments are described, wherein the subset of overlapping sets of the time samples begins where a sound in the sample begins.

Various embodiments are described, wherein input training samples include a two-dimensional data array where rows represent the plurality of sets of time samples for each sample and columns represent discrete frequencies of the frequency domain representation.

Various embodiments are described, wherein the plurality of sets of time samples are overlapping sets of time samples.

Various embodiments are described, wherein generating the overlay sequence includes selecting, by the processor, a set of frequencies for the overlay sequence and setting an amplitude value at the selected set of frequencies based upon the unique data input.

Various embodiments are described, wherein the unique data input is text data, and the amplitude values are based on characters in the text data.

Various embodiments are described, wherein the selected set of frequencies are non-contiguous.

Various embodiments are described, wherein the ML model is a neural network.

Further various embodiments relate to a method for watermarking a machine learning model (ML), by a watermarking system, configured to classify time-series signals, the method including: selecting, by a processor of the watermarking system, a labeled set of ML training time-series signal samples to use for training the ML model; selecting, by the processor, a first subset of the labeled set of ML training samples for use in generating a watermark in the ML model, wherein the first subset is of a predetermined class of time-series signal classes and wherein each ML training sample includes a set of discrete time time-series signal samples; producing, by the processor, a plurality of sets of discrete time time-series signal samples for each sample of the first subset of labeled ML training data samples; performing, by the processor, a discrete Fourier transform on each of the sets of discrete time time-series signal samples to produce a discrete frequency domain representation of each sample of the first subset of labeled ML training data samples; generating, by the processor, one or more first overlay sequences based upon a first data string, wherein the first overlay sequence is a discrete frequency domain representation; combining, by the processor, each sample of the first subset of the labeled ML training data samples with a selected one of the one or more overlay sequences to produce a modified first subset; relabeling, by the processor, each sample of the modified first subset to have a different label than the first subset had before relabeling; and training, by the processor, the ML model with the labeled set of ML training samples and the relabeled modified first subset to produce a trained and watermarked ML model.

Various embodiments are described, wherein the first data string is copyrighted data.

Various embodiments are described, wherein combining the first overlay sequence with each sample of the first subset of the labeled ML training data samples is performed, by the processor, on a subset of overlapping sets of time samples for each sample.

Various embodiments are described, wherein the subset of overlapping sets of time samples begins where a sound in the sample begins.

Various embodiments are described, wherein combining the first overlay sequence with each sample of the first subset of the labeled ML training data samples includes calculating, by the processor, a weighted addition of the first overlay sequence with each sample of the first subset of the labeled ML training data samples.

Various embodiments are described, wherein input training samples include a two-dimensional data array where rows represent the plurality of sets of time samples for each sample and columns represent discrete frequencies of the frequency domain representation.

Various embodiments are described, wherein the plurality of sets of time samples are overlapping sets of time samples.

Various embodiments are described, wherein generating the first overlay sequence includes selecting, by the processor, a set of frequencies of the first overlay sequence and setting an amplitude value at the selected set of frequencies based upon characters of the first text string.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 illustrates how a watermark and copyrighted material may be used to watermark a ML model.

FIG. 2 illustrates ML model that receives a sampled audio signal as an input and produces a label that indicates the spoken word contained in the sampled audio signal.

FIG. 3 illustrates nine different example sampled audio signals for different words.

FIG. 4 illustrates sampled audio signal that carries the sound for the word UP having a duration of T.

FIG. 5 illustrates how input sample signals are processed and then used to train the ML model.

FIG. 6 broadly describes the process described above for adding an overlay sequence to samples in a training data set.

FIG. 7 illustrates a first embodiment of a method for training a ML to have a watermark.

FIG. 8 illustrates a second embodiment of a method for training a ML to have a watermark.

FIG. 9 illustrates an exemplary hardware diagram for training a watermarked ML model.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented, or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of ML systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

The use of machine learning algorithms, and neural networks in particular, is growing rapidly. The quality of such algorithms heavily depends on the quality of the data. The ML model is trained using training data, which is often costly and even difficult to obtain. This makes the ML model a valuable and differentiating asset for the developer of the ML model. This raises the question of how to protect such a ML model. In U.S. Pat. Nos. 11,809,531, 11,699,208, and 12,013,922, watermarking schemes for vision problems are described and these patent applications are incorporated by reference for all purposes as if included here. In U.S. application Ser. No. 18/347,740, a watermarking scheme for sensor data is described and this patent application is incorporated by reference for all purposes as if included herein.

These watermarking schemes include a human creative aspect added to a model, which strengthens the copyright protection on the model and enables a developer to prove that a model is a copy or clone of the model they developed. If the developer discovers a copy of their ML model, the developer can next take legal action to prevent the adversary from further profiting from the unauthorized use of the model and the unfair competition that results from the savings on the development cost of the replicated ML model that has been stolen. This disclosure describes a watermarking scheme that works for ML models that work with time-series signal input problems, for example where the ML model classifies sounds in audio signals. The time series signals might include electro-cardiograms (EKGs), stock prices, number of sunspots, outside temperature, network traffic, vehicle traffic, etc.

Today more and more systems are being implemented via ML models. This is especially true of classification systems for which ML models (e.g., deep learning neural networks) are especially well suited. The ML model may be trained with a large number of labelled inputs so that the resulting ML models accurately classify input. Some of the properties of ML models include flexibility, ability to handle large amounts of data, case of customization, and ability to solve problems that are hard to solve by standard algorithms. For example, these ML models may detect patterns in data that are difficult for a human to discern. Further, ML models excel at image and sound classification tasks. ML models can be classified based upon their architecture and the way that they are trained. Training options may include supervised learning, unsupervised learning, semi-supervised learning, and reinforcement learning.

In this disclosure, the focus is on supervised learning in which the ML model is trained using data of which the desired output is given. Such training data is called labeled data. The data in the data set may be divided into three sets of data to facilitate training of the ML model. These include the training set, test set, and validation set. The training set and validation set are used during the actual training of the ML model. The test data may then be used to determine if the validated model is meeting desired performance characteristics.

The effectiveness of an ML model that may be determined by its accuracy, execution time, and storage requirements, heavily depends on the quality (as well as quantity) of the available training data. Because access to particular data is typically a differentiator to a ML model developer, this makes ML models often a very valuable asset. However, it has been demonstrated that even in the when a machine learning model is stored securely (e.g., in the cloud or by having platform security), it is still vulnerable to an attacker that tries to copy or steal it. Only a black-box access to ML model's input/output behavior suffices to get a nearly perfect clone of the ML model. This may be done by generating a large data set including a number of potential inputs into the ML model. This data set is then fed into the targeted ML model and the outputs of the ML model are used to label the associated input data. This results in a large labeled data set that may then be used to train a new ML model that mimics the behavior of the target ML model. Once the cloned ML model has been developed, the adversary can monetize it. Because the adversary does not have to invest in the development of the ML model, they can produce their own cloned ML model at a much lower cost.

In this disclosure, embodiments of an approach for embedding a watermark in a ML model are described such that, if the ML model is stolen by an attacker—either by copying the memory or by a cloning attack via the external application program interface (API)—the owner of the ML model can detect the cloned or stole ML model and prove that it was cloned or stolen, even if the attacker has only access to the external API.

The watermarking scheme proposed in this disclosure is based on the idea of so-called trigger inputs. These trigger inputs are specially-crafted inputs that trigger a hidden, secret functionality in a machine-learning model. This functionality can be used for proving ownership of the ML model. In addition to proving ownership, a piece of copyrighted material may be added into the ML model to provide the developer of the ML model an addition basis for a copyright claim against the party who stole or cloned the ML model. This is important as the copyright protection for the ML model itself is potentially not as strong as the copyright protection for other types of traditional copyrighted materials.

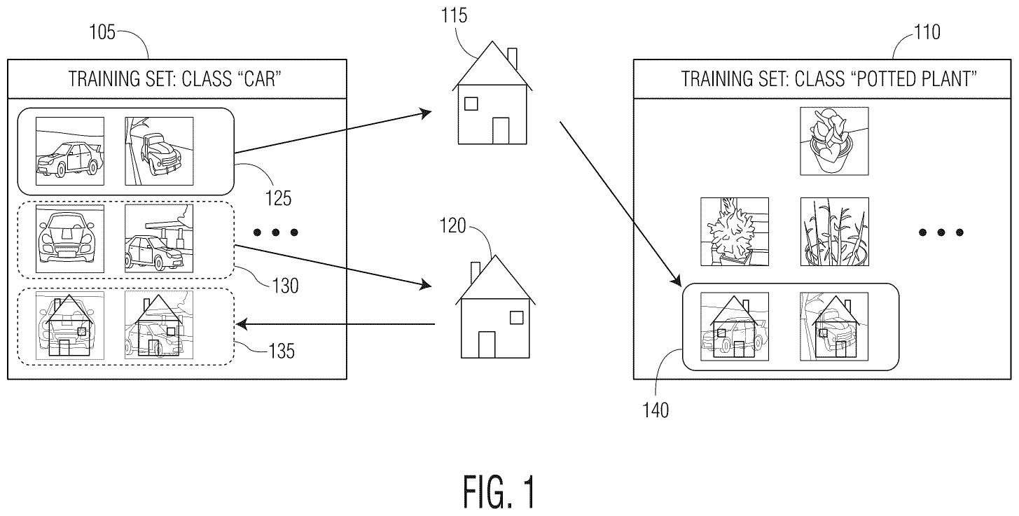

To start, an example of watermarking images with a copyrighted drawing will first be described to broadly describe the problem and a broad solution to the problem in the case of images. FIG. 1 illustrates how a watermark and copyrighted material may be used to watermark a ML model. FIG. 1 illustrates a first training set 105 and a second training set 110. The first training set 105 may include for example images of cars. The second training set 110 may include images of potted plants. These training sets illustrate two different classes of photos that the ML model will be trained to classify. The ML model may also be trained to classify photos in many other classes, but the two are used here as an example. FIG. 1 also illustrates a first drawing 115 and a second drawing 120. In this example the first drawing 115 and second drawing 120 are different drawings of a house in two different positions. These drawings may be copyrighted by the developer of the ML model. The first drawing 115 may be combined with a first car image 125 to create a second car image 140 with the house image overlaid. The second car image 140 is placed in the second training set 110 for potted plants. The second car image 140 will generally look like a car, but the ML model will be trained to classify the second car image 140 as a potted plant. Therefore, the second car image 140 may be used by the developer of the ML model to identify their ML model by inputting the second car image 140 into the ML, and when the second car image 140 is classified by the ML model as a potted plant the developer will know that the associated ML model is theirs or at least derived from their ML model.

Further, the second drawing 120 may be combined with a third image 130 to produce a fourth image 135. The fourth image 135 looks like a car and is placed in the first training set 105 for cars.

In the illustrative example of FIG. 1, the ML model may be trained using the different training sets 105 and 110. Subsequently, the model may classify new inputs based on the training sets, allowing the owner of the ML model to use the “potted plant” classified image 140 to test other models to determine theft. While the above-discussion introduces a method of detecting theft of the ML model based on a training set that includes a deliberately miscategorized image or text; however, an ML model may also be trained to classify audio files.

In this disclosure, embodiments of audio classifiers are disclosed having inputs that are sounds and outputs are that categories, and audio signals are used as an example of a time-series signal. The embodiments described herein work with any type of time-series signal that may be classified based upon its characteristics. The focus is on supervised learning which means that a model is trained using labeled data. Furthermore, any type of model may be used, including but not limited to, neural networks, support vector machines, decision trees, etc.

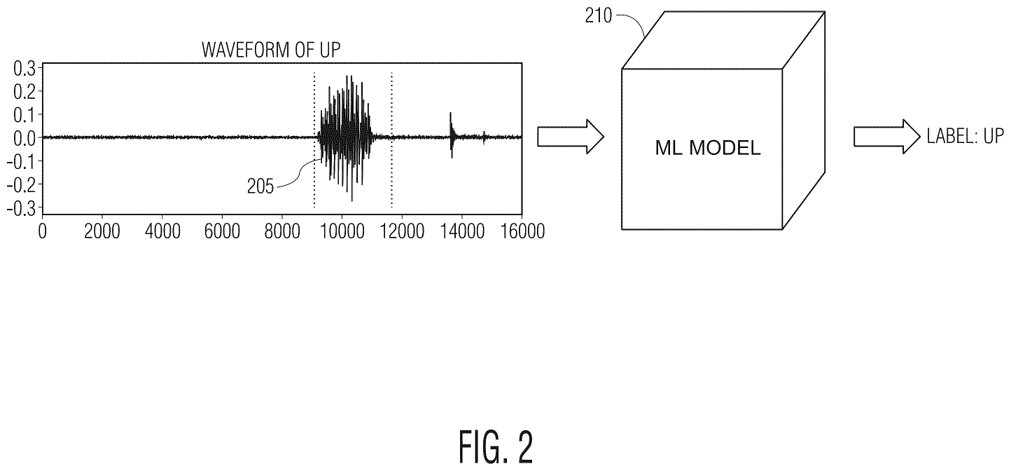

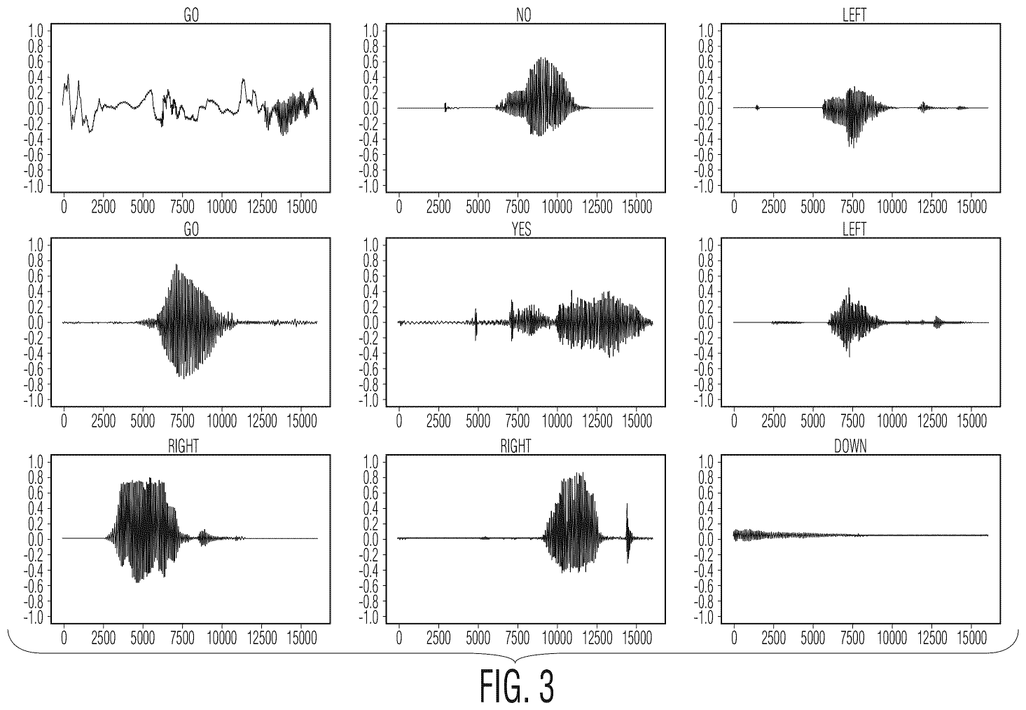

FIG. 2 illustrates ML model 210 that receives a sampled audio signal 205 as an input and produces a label that indicates the spoken word contained in the sampled audio signal 205. In this example the sampled audio signal 205 is the spoken word “UP”. In this specific example there may be eight different words contained in the sampled audio signal 205: “UP”; “DOWN”, “NO”; “YES”; “LEFT”; “RIGHT”; “STOP”; and “GO”. FIG. 3 illustrates nine different example sampled audio signals for different words. The labeled sampled audio signals may be used to train the ML model 210.

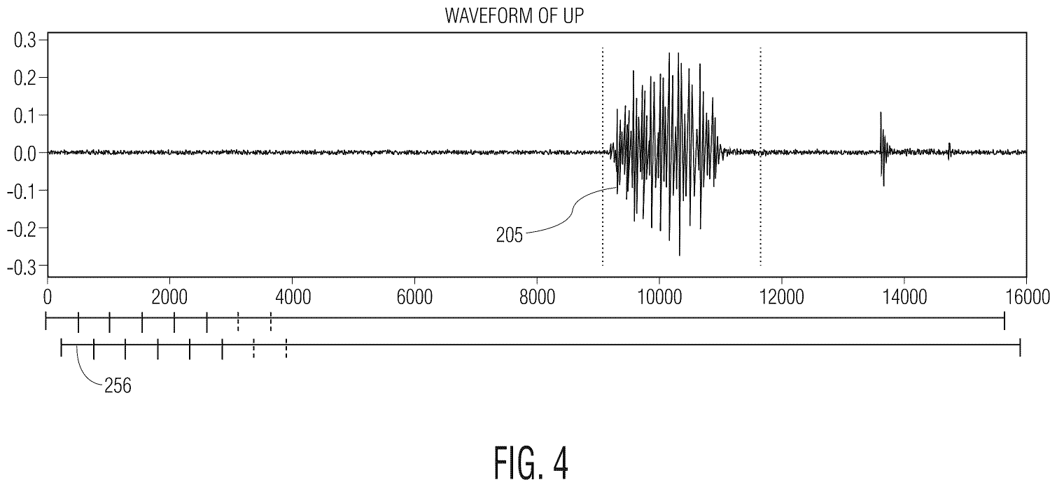

It is assumed that the sounds represented by the sampled audio signals on which the ML model is trained and for which predictions need to be made are digitally sampled at a frequency fs and have a duration T. FIG. 4 illustrates sampled audio signal 205 that carries the sound for the word UP having a duration of T. The time interval T can be split into, possibly overlapping, intervals Tᵢ of equal length such that ∪ᵢTᵢ equals T. In this example, the sample has a duration T of 1 second. The sampling frequency fₛ is 16 KHz resulting in 16,000 samples. Further, each Tᵢ may include 256 samples. With 16,000 samples, there are 124 intervals (2*16,000/256=124). The part of sound S in time interval Tᵢ is called Sᵢ. There is a finite set F of frequencies f₁, f₂, . . . , fₘ such that in each time interval Tᵢ, Sᵢ may be approximated by a sum of sines of these frequencies. More precisely, this means that for an interval Tᵢ a set of numbers (amplitudes) a₁, a₂, . . . , aₘ and a set of numbers (phases) φ₁, φ₂, . . . , φₘ may be found such that Sᵢ (n) is approximated by

$${\sum }_{j = 1}^{j = m} {a}_{j} sin ( 2 π {f}_{j} n / N + {φ}_{j} ) ,$$

where N is the number of samples in Tᵢ and n ranges over the numbers 1 . . . N. In one or more embodiments, this may be performed using a discrete Fourier transform implemented using a fast Fourier transform algorithm.

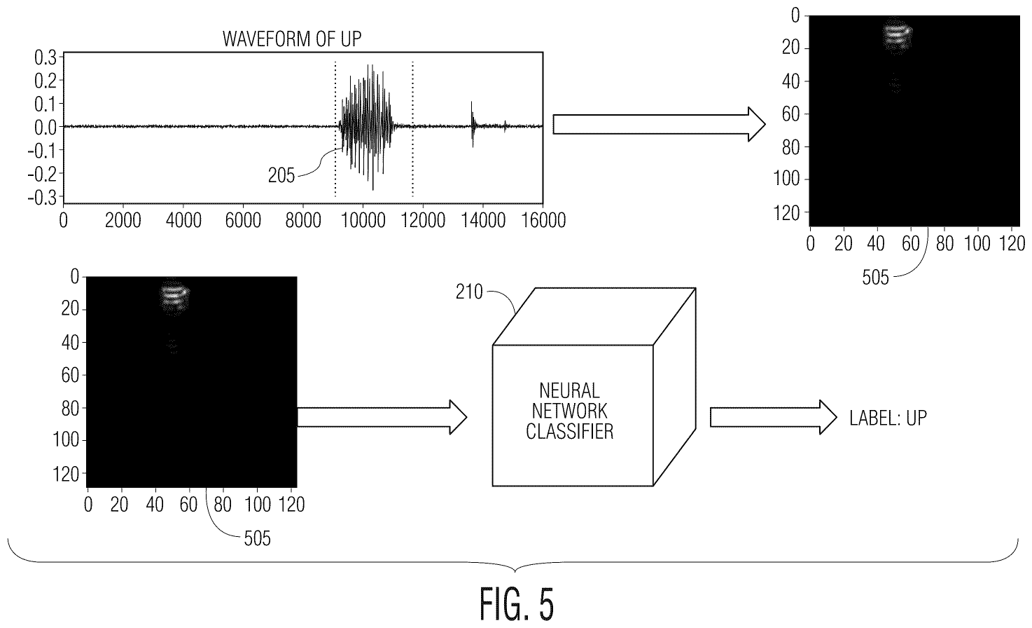

FIG. 5 illustrates how input sample signals are processed and then used to train the ML model. The sampled audio signal 205 is processed as described above by splitting the sampled audio signal 205 into a plurality of overlapping time intervals. Each of the samples in each of the overlapping time intervals may be transformed into the frequency domain, using for example a fast Fourier transform. These frequency domain representations of the overlapping time intervals may be organized into a two-dimensional matrix 505 where the rows represent each overlapping time interval, and the columns represent the different discrete frequency components of the overlapping time intervals. These two-dimensional matrices 505 may be produced for each of the samples in the training data set and then be used to train the ML model 210 (which in this example may be a neural network classifier). When a specific two-dimensional matrix 505 that represents the audio for the word “UP” is input to the ML model 210, the ML model 210 produces a classification output of “UP”. Note, that in other embodiments, a plurality of time samples may be used that are not overlapping.

In this disclosure, a watermarking scheme is described based on trigger inputs. This watermarking scheme serves two purposes: it can be used to prove that two models are copies or clones of each other; and the scheme embeds a copyrighted asset in the ML model, which helps to provide a copyright claim against a copyist. This watermarking scheme may be implemented by a watermarking system having a processor executing instructions to carry out these steps. The processor may include a general purpose processor, a graphics processor, a neural network processor, etc.

It will now be described how to incorporate copyrighted material into the model. Let C be a string of numbers with length s that is based on a human-creative element, such as text, an image, or audio. The string C can take other forms as well and may be any unique data input that is known to the developer and that may include copyrighted information. In the examples described herein, it is assumed that the string C represents English text, such as a short poem or part of a paper. The ML model 210 is trained with a set of labelled sounds, i.e., a number of different sampled audio signals with different examples of the eight label words. Then a selection of these sounds may be selected and the training set may be extended by embedding a portion of the string C in each of the sounds of this selection. The same embedding of string C in other test-sounds can be used to produce trigger sounds that can be used to determine whether a model is a copy or clone of the owner's ML model 210.

First it will be described how to embed the string C into a sound S to generate a trigger sound that can either be added to the training set or used to check whether the ML model 210 contains the watermark. This embedding may be done using the following steps. These steps may be carried out by the watermarking system.

First, a fixed subset of k frequencies \hat{f}₁, \hat{f}₂ . . . , \hat{f}ₖ are selected from a finite set of frequencies F.

For a sound S, a number of (not necessarily successive) time intervals \hat{T}=\hat{T}₁, \hat{T}₂, . . . , \hat{T}ₗ are selected such that l×k≥s.

The string C is split into l substrings C₁ . . . Cₗ each of length k. The last substring(s) may possibly be padded.

Now the l substrings of C are embedded into the l time intervals in \hat{T}. First, for each substring Cⱼ define an overlay sequence Wⱼ of length N, which is the same as the length of \hat{T}ⱼ. This overlay sequence Wⱼ is obtained by summing sines with the k selected frequencies such that the amplitudes of the k sines are given by the k numbers in substring Cⱼ. Formally, this means

$${W}_{j} ( n ) = {\sum }_{i = 1}^{i = k} {C}_{ji} sin ( 2 π {\hat{f}}_{i} \frac{n}{N} ) ,$$

where n ranges over the numbers 1 . . . N and Cut is the i-the element of substring Cⱼ.

Next these overlay sequences Wⱼ are added to sound S via selected weights α and β by replacing, for each time interval \hat{T}ⱼ from \hat{T}, the values of Sⱼ with αSⱼ+βWⱼ.

When the ML model 210 is trained using these modified Sⱼ values, the ML model 210 is now based upon the copyrighted material string C, so that if another party tries to copy or otherwise take the ML model, the party will be in violation of copyright law.

Next it will be described how to watermark the ML model. 210. This watermarking may be carried out by the watermarking system. This may be done by defining watermarking training samples with a source label λ that result in an output from the ML model with a target label τ where λ≠τ. These watermarking training samples may be selected as a subset V of the training sounds with label λ. The copyrighted string C may be embedded in these watermarking training samples as defined above, and the label for each of the subset with the embedded string C may be changed from λ to τ. These watermarking training samples are added to the training set.

Further, some other strings of numbers Ca₁, . . . , Caₚ (similar to C but not equal to C) may be generated and embedded in training samples from V in the same way as described above, and these modified training samples may keep their original label λ. These training samples are also added to the training set.

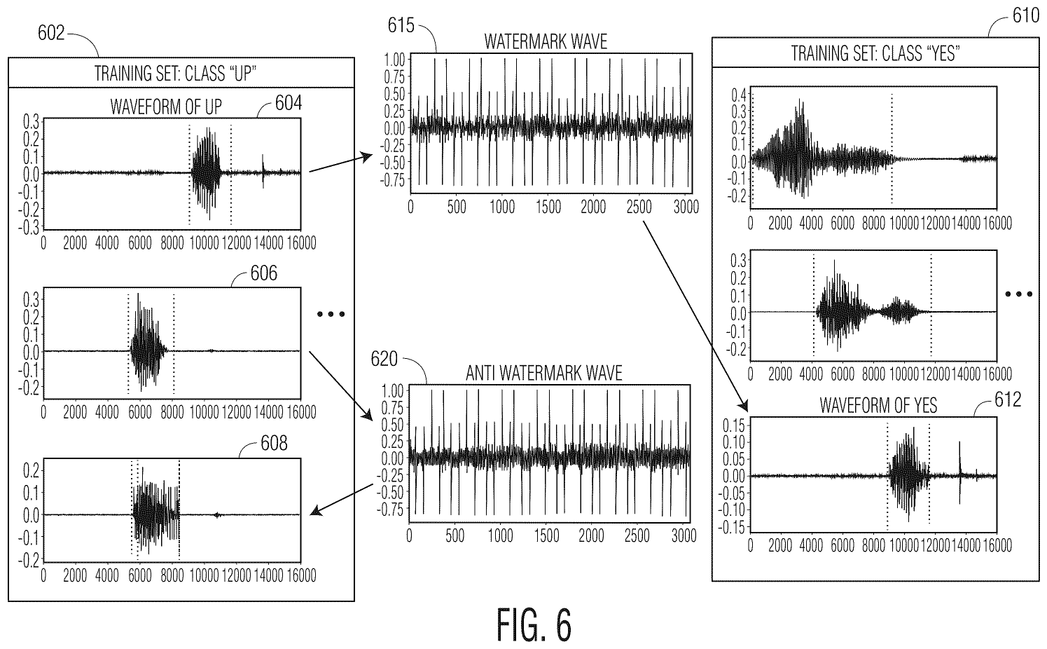

FIG. 6 broadly describes the process described above for adding an overlay sequence to samples in a training data set. In FIG. 6 a training set associated with the “UP” 602 and a training set associated with “YES” 610 are illustrated. A first overlay sequence 615 may be generated as described above and then combined with the UP sample 604. This combined UP sample is then labeled with the label “YES” and placed as a sample 612 in the training set associated with “YES” 610. Further, a second overlay sequence 620 may be generated. This may be combined with the UP sample 606. This combined UP sample is labeled with the label “UP” and placed as a sample 608 in the training set associated with “UP” 602.

Once trained with the training set associated with “UP” 602 and the training set associated with “YES” 610 (and alternatively with additional training sets associated with other classes), copying or cloning of the trained ML model may be readily detected. A watermarking check system may check a ML model to determine if it copied or cloned. This watermarking check system may be implemented by a processor executing instructions to carry out these steps. The processor may include a general-purpose processor, a graphics processor, a neural network processor, etc. The watermarking check system may select some sounds that have clear label λ and make trigger samples of them by embedding our string C in them. The ML model, or a copy or clone of the ML model, will classify these trigger samples with high probability as label τ despite the fact that trigger samples sound most like sounds of label λ. If trigger samples of these sounds with a different sequence than C is used, these trigger samples will be classified by the model as label λ.

A description of how to implement a ML model as described above will now be provided. In this example the “speech commands” data set by Tensorflow is used. This is a subset of the data set described by Pete Warden in https://arxiv.org/abs/1804.03209. The labels are “DOWN”, “GO”, “LEFT”, “NO”, “RIGHT”, “STOP”, “UP” and “YES”. For each label there arc 1000 sounds. Each sound takes 1 second and is sampled at 16,000 kHz, resulting in 16,000 samples. The ML model will be described at a high level. The sound samples are grouped into subsets N such that half of each subset overlaps adjacent subsets (half overlapping intervals) with each subset N including 256 values. Thus, the 16,000 sound samples may be subdivided into 124 subsets N with 256 values per subset. A discrete Fourier transform is performed on each interval (subset N) from which the phase information may be discarded and the magnitude information may be determined. Because the magnitudes of a discrete Fourier transform are symmetric, 256/2+1=129 frequency values may be determined. Thus, this Fourier transform produces a sound matrix of 124×129 values. The process may be repeated for each of the sounds to produce a plurality of matrices.

Then the Tensorflow Keras function “Resizing” may be used to resize each matrix to a 32×32 matrix and to normalize the values such that all entries of the 32×32 matrix have similar distributions over the whole training set. With these resized 32×32 matrices for sounds, a neural network is trained that includes a sequence of two convolutional layers, a maxpooling layer, a dropout layer, a first dense layer, a second dropout layer, and a final dense layer. The convolutional layers and the first dense layer are followed by a rectified linear unit (ReLu). On this data set and this model, the ML model training approached described herein has been applied.

In this example, the source label A has been selected to be the label “UP” and as target label t has been selected to be the label “YES”. One hundred training sounds with label “UP” were selected in which the copyrighted string will be inserted. The selected training sounds may be selected from the sounds that have an amplitude that is greater than a minimal threshold and have background noise below a background threshold.

As a copyrighted element, the first 308 characters of the first sentences of an abstract of one of a technical paper were selected. These 308 characters were converted to a string of numbers C by mapping the “a” to 0, “b” to 1, etc. The capitalization of the characters was ignored for this example. There were eight special characters found in these sentences, such as spaces, dots, question marks etc., which were mapped to the values 26 to 33. Additionally, as described above, one hundred eighty strings of numbers Ca₁, . . . , Ca₁₈₀ were determined from text of a book. Each of these one hundred eighty strings of numbers was derived from at least a portion of a sentence of 308 characters in the same way as described above with respect to the string C.

A watermarking system may choose a plurality of frequencies could be from 129 frequencies (where k=129). In one or more embodiments, the watermarking system may select lowest frequency may be selected as the first frequency \hat{f}₁ and then every third frequency may be selected until frequency \hat{f}₁₁₅ (e.g., \hat{f}₄, \hat{f}₇, . . . , \hat{f}₁₁₅), providing thirty-eight selected frequencies (kₛₑₗ=38). The set of frequencies used in this step may be selected in various other ways as well. Frequencies selected here are not contiguous frequencies, but, in an alternative embodiment, contiguous frequencies could be used.

For each sound to be modified, eight consecutive time intervals \hat{T}₁, \hat{T}₂, . . . , \hat{T}ₗ (l=8) were selected to embed a selected string C and the strings Ca₁, . . . , Ca₁₈₀. Any number of consecutive time intervals may be used. Also, in other embodiments, the time intervals may not overlap and/or may not be consecutive. Each time interval is a union of two consecutive half overlapping intervals of 256 values that were used for the discrete Fourier transform. Thus, each time interval has 384 values. In one or more embodiments, a point at which the spoken word “UP” begins within the sound data may be located automatically by the watermarking system. The start of the first time interval overlay sequence may be selected automatically to correspond to the point at which the spoken word “UP” starts. By selecting the first time interval of the overlay sequence to coincide with the beginning of the sound within the sound data, the added overlay sequence may be mixed with the sound as opposed to being mixed with a part of the sample that includes silence.

The strings C and Ca₁, . . . , Ca₁₈₀ may be broken into eight parts, each having a length of thirty-eight bytes and each part may be assigned to one of the eight time intervals. For each interval \hat{T}ⱼ from \hat{T}, an overlay sequence Wⱼ is defined. This may be done by defining a set of thirty-eight discrete functions

$${G}_{ij} ( n ) = {a}_{i} sin ( 2 π {\hat{f}}_{i} \frac{n}{256} ) ,$$

(0≤n<384) in which the amplitude aᵢ is the i-th element of Cⱼ, the part of string C for \hat{T}ⱼ. Therefore, the overlay sequence Wⱼ is defined as

$${W}_{j} = {\sum }_{i = 1}^{i = 38} {G}_{ji} ( n ) , \\ where 0 \leq n < 384.$$

Next these overlay sequences Wⱼ are added to the sound S via selected weights α and β by replacing, for each time interval \hat{T}ⱼ from \hat{T}, the values of Sⱼ with αSⱼ+βWⱼ. In the 100 selected training sounds with label “UP”, the string C is embedded by replacing Sⱼ, the values of the sound within the intervals \hat{T}ⱼ, by the values 0.6 Sⱼ+0.4 Wⱼ for j in the set 1, . . . , 8 (i.e., α=0.6, β=0.4).

These samples are added to the training set with label “YES”. A sound from these 100 sounds is also selected randomly 180 times and strings Caⱼ (j in the set 1, . . . , 180) are embedded into these sounds in a similar way. Note that the same sound can be selected multiple times. These new sounds may be added to the training set with label the “UP”.

If a ML model 210 is trained with this extended data set, the resulting model has the sound watermarking functionality. That is, if the model is fed a trigger input sound that is an “UP” in which string C is embedded in the above-described way, the resulting ML model will classify this trigger sound with high probability as “YES”. If a trigger input sound is made with another string, the trigger input sound will be classified with high probability as “UP”. The probability that an independently trained ML model has this same functionality is negligible.

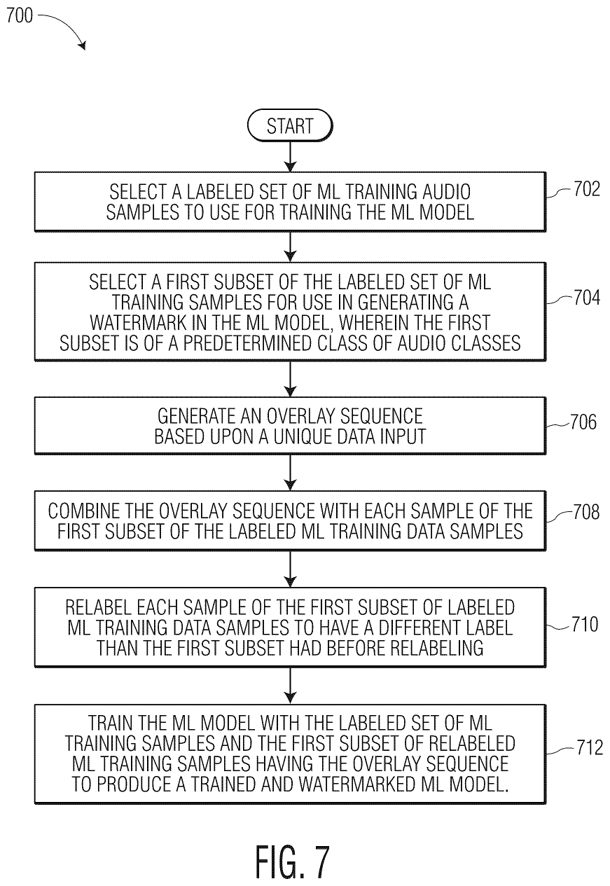

FIG. 7 illustrates a first embodiment of a method for training a ML to have a watermark. The watermarking system may carry out this training method 700. The training method 700 at step 702 selects a labeled set of ML training audio samples to use for training the ML model. The labeled set of ML training audio samples may be a subset selected from a large set of labeled ML training audio samples. The labeled set that was selected may include a plurality of audio samples and may include a variety of labels.

Next the training method 700 at step 704 selects a first subset of the labeled set of ML training samples for use in generating a watermark in the ML model, wherein the first subset is of a predetermined class of audio classes. In an example, the first subset may be selected from the labeled set based on the pre-determined labels so that the samples of the first subset may have the same label.

Then at step 706, the training method 700 generates an overlay sequence based upon a unique data input. In one or more embodiments, the unique data input may be determined from one or more copyrighted digital files. The unique data input may be based one or more selected portions of one or more copyrighted files. Such unique data input may include a poem, a copyrighted sound or sound sequence, a copyrighted image, copyrighted text, and the like, which may be selected and processed to generate the overlay sequence.

At step 708, the training method 700 combines the overlay sequence with each sample of the first subset of the labeled ML training data samples. In one or more embodiments, multiple overlay sequences may be generated, and each sample may be combined with a selected one of the multiple overlay sequences.

Next at step 710, the training method 700 relabels each sample of the first subset of labeled ML training data samples to have a different label than the first subset had before relabeling. The samples with the overlay sequence(s) may be relabeled such that the original label is replaced with a “new” label.

At step 712, the training method 700 trains the ML model with the labeled set of ML training samples and the first subset of relabeled ML training samples having the overlay sequence to produce a trained and watermarked ML model. In one or more embodiments, the ML model is understood to be watermarked by the samples with the overlay sequence(s) that are relabeled. Subsequently, the ML model may be tested using a sample combined with the overlay sequence, and the ML Model should return the “new” label reflecting the relabeled samples, if the ML Model was copied or cloned. Thus, the “watermarked” ML model can be identified in order to identify theft of the model.

In one or more alternative embodiments, one or more second overlay sequences may be generated, which may be combined with one or more samples of the first subset of the labeled ML training data samples. These second overlayed samples may retain their original label and may be added to the training data used to train the ML model.

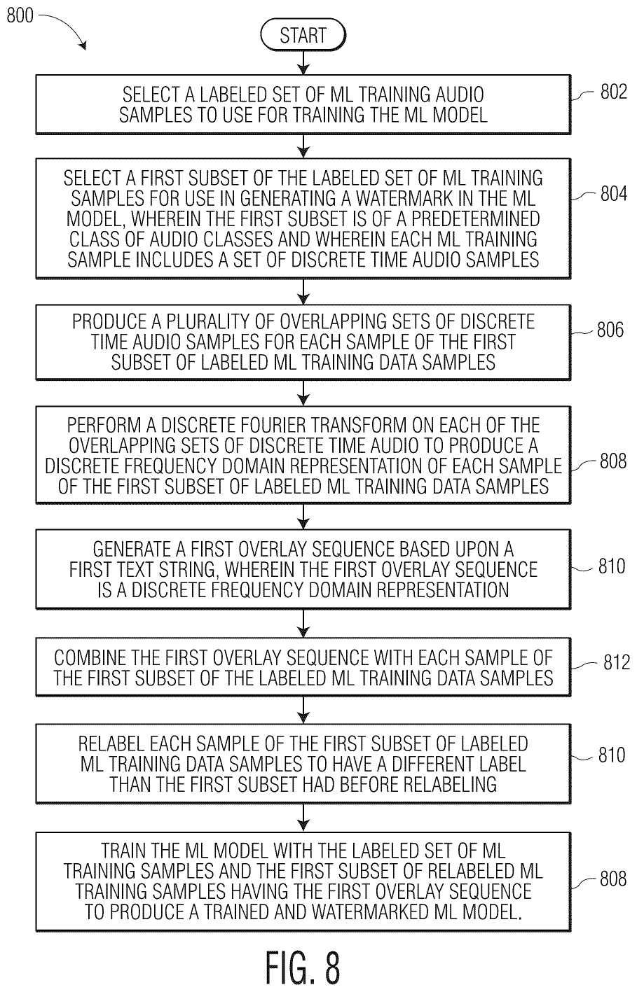

FIG. 8 illustrates a second embodiment of a method for training a ML to have a watermark. The watermarking system may carry out this training method 800. The training method 800 at step 802 selects a labeled set of ML training audio samples to use for training the ML model. In one or more embodiments, the labeled set of ML training audio samples may be selected from a larger data set of ML training audio samples. The labeled set of ML training audio samples may include audio samples having different labels.

Then at step 804, the training method 800 selects a first subset of the labeled set of ML training samples for use in generating a watermark in the ML model, wherein the first subset is of a predetermined class of audio classes and wherein each ML training sample includes a set of discrete time audio samples. In one or more embodiments, the first subset may be selected from the labeled set such that each audio sample of the first subset has the same label, which may correspond to the predetermined class or classification.

The training method 800 at step 806 produces a plurality of overlapping sets of discrete time audio samples for each sample of the first subset of labeled ML training data samples. In one or more embodiments, the overlapping sets of discrete time audio samples may overlap adjacent samples by approximately half of the samples (half of the time interval).

At step 808, the training method 800 performs a discrete Fourier transform on each of the overlapping sets of discrete time audio to produce a discrete frequency domain representation of each sample of the first subset of labeled ML training data samples. The training method 800 at step 810 generates a first overlay sequence based upon a first text string, wherein the first overlay sequence is a discrete frequency domain representation. In one or more embodiments, the first text string may correspond to at least a portion of a copyrighted work. While step 810 discloses a first overlay sequence, in one or more embodiments, multiple overlay sequences may be generated based one or more test strings. In one or more other embodiments, the first overlay sequence may be based upon a data string derived from one of an image file, an audio file, or a text document. In an example, the string may be extracted from a copyrighted audio file by performing a discrete Fourier transform on a portion of the audio file to produce a discrete frequency domain representation of the portion of the audio file. The overlay sequence may be generated based on the discrete frequency domain representation.

At step 812 the training method 800 combines the first overlay sequence with each sample of the first subset of the labeled ML training data samples. In one or more other embodiments, the method 800 may include combining each sample with a selected one of a plurality of overlay sequences.

Next at step 814, the training method 800 relabels each sample of the first subset of labeled ML training data samples to have a different label than the first subset had before relabeling. In one or more embodiments, the labels are changed to intentionally misclassify the audio sample to train the ML model to return the wrong classification for a different sound sample having a similar overlay sequence.

Then the training method 800 at step 816 trains the ML model with the labeled set of ML training samples and the first subset of relabeled ML training samples having the first overlay sequence to produce a trained and watermarked ML model.

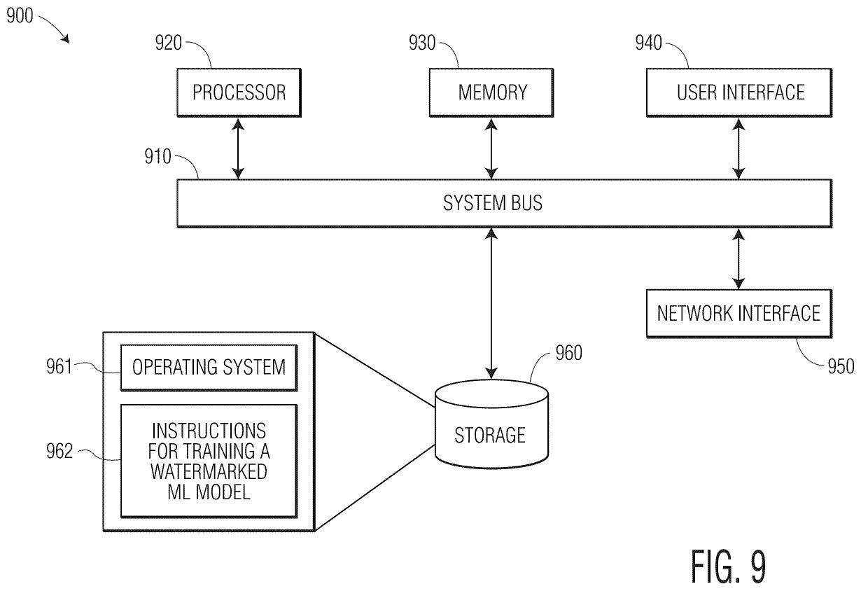

FIG. 9 illustrates an exemplary hardware diagram 900 for training a watermarked ML model. The exemplary hardware 900 may implement the methods illustrated in FIGS. 7 and 8. As shown, the device 900 includes a processor 920, memory 930, user interface 940, network interface 950, and storage 960 interconnected via one or more system buses 910. It will be understood that FIG. 9 constitutes, in some respects, an abstraction and that the actual organization of the components of the device 900 may be more complex than illustrated.

The processor 920 may be any hardware device capable of executing instructions stored in memory 930 or storage 960 or otherwise processing data. As such, the processor may include a microprocessor, microcontroller, graphics processing unit (GPU), neural network processor, field programmable gate array (FPGA), application-specific integrated circuit (ASIC), or other similar devices.

The memory 930 may include various memories such as, for example L1, L2, or L3 cache or system memory. As such, the memory 930 may include static random-access memory (SRAM), dynamic RAM (DRAM), flash memory, read only memory (ROM), or other similar memory devices.

The user interface 940 may include one or more devices for enabling communication with a user such as an administrator. For example, the user interface 940 may include a display, a touch interface, a mouse, and/or a keyboard for receiving user commands. In some embodiments, the user interface 940 may include a command line interface or graphical user interface that may be presented to a remote terminal via the network interface 950.

The network interface 950 may include one or more devices for enabling communication with other hardware devices. For example, the network interface 950 may include a network interface card (NIC) configured to communicate according to the Ethernet protocol or other communications protocols, including wireless protocols. Additionally, the network interface 950 may implement a TCP/IP stack for communication according to the TCP/IP protocols. Various alternative or additional hardware or configurations for the network interface 950 will be apparent.

The storage 960 may include one or more machine-readable storage media such as read-only memory (ROM), random-access memory (RAM), magnetic disk storage media, optical storage media, flash-memory devices, or similar storage media. In various embodiments, the storage 960 may store instructions for execution by the processor 920 or data upon with the processor 920 may operate. For example, the storage 960 may store a base operating system 961 for controlling various basic operations of the hardware 900. The storage 960 may include instructions for training a watermarked ML model 962, which may be executed by the processor 920.

When executed, the instructions 962 for training the watermarked ML model may cause the processor 920 to automatically generate a training set for the ML model. The instructions 962 may cause the processor 920 to automatically select a training set of labeled audio samples from a database of labeled audio samples and to automatically select a subset of the training set that have the same classification or label from the selected training set. The instructions 962 may cause the processor 920 to automatically select one or more data strings from one or more copyrighted works (text files, image files, or audio files) and to automatically generate one or more overlays based on the one or more data strings. The instructions 962 may cause the processor 920 to combine each sample of the selected subset with one of the one or more overlays and to relabel each sample from its original label to new label (a different classification). The instructions 962 may cause the processor 920 to train the ML model using the selected training set and the relabeled subset to produce the watermarked ML model. The watermarked ML model may be deployed for use, and other ML models may be tested to determine whether the other ML models are clones of the watermarked ML model based on the relabeled subset.

It will be apparent that various information described as stored in the storage 960 may be additionally or alternatively stored in the memory 930. In this respect, the memory 930 may also be considered to constitute a “storage device” and the storage 960 may be considered a “memory.” Various other arrangements will be apparent. Further, the memory 930 and storage 960 may both be considered to be “non-transitory machine-readable media.” As used herein, the term “non-transitory” will be understood to exclude transitory signals but to include all forms of storage, including both volatile and non-volatile memories.

The system bus 910 allows communication between the processor 920, memory 930, user interface 940, storage 960, and network interface 950.

While the host device 900 is shown as including one of each described component, the various components may be duplicated in various embodiments. For example, the processor 920 may include multiple microprocessors that are configured to independently execute the methods described herein or are configured to perform steps or subroutines of the methods described herein such that the multiple processors cooperate to achieve the functionality described herein. Further, where the device 900 is implemented in a cloud computing system, the various hardware components may belong to separate physical systems. For example, the processor 920 may include a first processor in a first server and a second processor in a second server.

The foregoing disclosure provides illustration and description but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software.

As used herein, satisfying a threshold may, depending on the context, refer to a value being greater than the threshold, greater than or equal to the threshold, less than the threshold, less than or equal to the threshold, equal to the threshold, not equal to the threshold, and/or the like. It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, the term “non-transitory machine-readable storage medium” will be understood to exclude a transitory propagation signal but to include all forms of volatile and non-volatile memory. When software is implemented on a processor, the combination of software and processor becomes a specific dedicated machine.

Because the data processing implementing the embodiments described herein is, for the most part, composed of electronic components and circuits known to those skilled in the art, circuit details will not be explained in any greater extent than that considered necessary as illustrated above, for the understanding and appreciation of the underlying concepts of the aspects described herein and in order not to obfuscate or distract from the teachings of the aspects described herein.

Unless stated otherwise, terms such as “first” and “second” are used to arbitrarily distinguish between the elements such terms describe. Thus, these terms are not necessarily intended to indicate temporal or other prioritization of such elements.

It should be appreciated by those skilled in the art that any block diagrams herein represent conceptual views of illustrative hardware embodying the principles of the aspects.

While each of the embodiments are described above in terms of their structural arrangements, it should be appreciated that the aspects also cover the associated methods of using the embodiments described above.

Unless otherwise indicated, all numbers expressing parameter values and so forth used in the specification and claims are to be understood as being modified in all instances by the term “about.” Accordingly, unless indicated to the contrary, the numerical parameters set forth in this specification and attached claims are approximations that may vary depending upon the desired properties sought to be obtained by embodiments of the present disclosure. As used herein, “about” may be understood by persons of ordinary skill in the art and can vary to some extent depending upon the context in which it is used. If there are uses of the term which are not clear to persons of ordinary skill in the art, given the context in which it is used, “about” may mean up to plus or minus 10% of the particular term.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

1. A method for watermarking a machine learning (ML) model, by a watermarking system, configured to classify time-series signals, the method comprising:
selecting, by a processor of the watermarking system, a labeled set of ML training time-series signal samples to use for training the ML model;
selecting, by the processor, a first subset of the labeled set of ML training samples for use in generating a watermark in the ML model, wherein the first subset is of a predetermined class of time-series signal classes;
generating, by the processor, an overlay sequence based upon a unique data input;
combining, by the processor, the overlay sequence with each sample of the first subset of the labeled ML training data samples;
relabeling, by the processor, each sample of the first subset of labeled ML training data samples to have a different label than the first subset had before relabeling; and
training, by the processor, the ML model with the labeled set of ML training samples and the first subset of relabeled ML training samples having the overlay sequence to produce a trained and watermarked ML model.

2. The method of claim 1, wherein the unique data input is copyrighted data.

3. The method of claim 1, further comprising:
producing, by the processor, a frequency domain representation of each sample of the first subset of labeled ML training data samples,
wherein generating an overlay sequence includes producing, by the processor, a frequency domain representation of the overlay sequence based upon the unique data input; and
wherein combining the overlay sequence with each sample of the first subset of the labeled ML training data samples includes calculating, by the processor, a weighted addition of the overlay sequence with each sample of the first subset of the labeled ML training data samples.

4. The method of claim 3, further comprising:
producing, by the processor, a plurality of sets of time samples for each sample of the first subset of labeled ML training data samples,
wherein producing a frequency domain representation of each sample of the first subset of labeled ML training data samples includes performing, by the processor, a frequency transformation on each of the plurality of sets of time samples.

5. The method of claim 4, wherein combining the overlay sequence with each sample of the first subset of the labeled ML training data samples is performed, by the processor, on a subset of overlapping sets of time samples for each sample.

6. The method of claim 5, wherein the subset of overlapping sets of the time samples begins where a sound in the sample begins.

7. The method of claim 4, wherein input training samples include a two-dimensional data array where rows represent the plurality of sets of time samples for each sample and columns represent discrete frequencies of the frequency domain representation.

8. The method of claim 4, wherein the plurality of sets of time samples are overlapping sets of time samples.

9. The method of claim 3, wherein generating the overlay sequence includes selecting, by the processor, a set of frequencies for the overlay sequence and setting an amplitude value at the selected set of frequencies based upon the unique data input.

10. The method of claim 9, wherein
the unique data input is text data, and
the amplitude values are based on characters in the text data.

11. The method of claim 9, wherein the selected set of frequencies are non-contiguous.

12. The method of claim 1, wherein the ML model is a neural network.

13. A method for watermarking a machine learning model (ML), by a watermarking system, configured to classify time-series signals, the method comprising:
selecting, by a processor of the watermarking system, a labeled set of ML training time-series signal samples to use for training the ML model;
selecting, by the processor, a first subset of the labeled set of ML training samples for use in generating a watermark in the ML model, wherein the first subset is of a predetermined class of time-series signal classes and wherein each ML training sample includes a set of discrete time time-series signal samples;
producing, by the processor, a plurality of sets of discrete time time-series signal samples for each sample of the first subset of labeled ML training data samples;
performing, by the processor, a discrete Fourier transform on each of the sets of discrete time time-series signal samples to produce a discrete frequency domain representation of each sample of the first subset of labeled ML training data samples;
generating, by the processor, one or more first overlay sequences based upon a first data string, wherein the first overlay sequence is a discrete frequency domain representation;
combining, by the processor, each sample of the first subset of the labeled ML training data samples with a selected one of the one or more overlay sequences to produce a modified first subset;
relabeling, by the processor, each sample of the modified first subset to have a different label than the first subset had before relabeling; and
training, by the processor, the ML model with the labeled set of ML training samples and the relabeled modified first subset to produce a trained and watermarked ML model.

14. The method of claim 13, wherein the first data string is copyrighted data.

15. The method of claim 13, wherein combining the first overlay sequence with each sample of the first subset of the labeled ML training data samples is performed, by the processor, on a subset of overlapping sets of time samples for each sample.

16. The method of claim 15, wherein the subset of overlapping sets of time samples begins where a sound in the sample begins.

17. The method of claim 13, wherein combining the first overlay sequence with each sample of the first subset of the labeled ML training data samples includes calculating, by the processor, a weighted addition of the first overlay sequence with each sample of the first subset of the labeled ML training data samples.

18. The method of claim 13, wherein input training samples include a two-dimensional data array where rows represent the plurality of sets of time samples for each sample and columns represent discrete frequencies of the frequency domain representation.

19. The method of claim 13, wherein the plurality of sets of time samples are overlapping sets of time samples.

20. The method of claim 13, wherein generating the first overlay sequence includes selecting, by the processor, a set of frequencies of the first overlay sequence and setting an amplitude value at the selected set of frequencies based upon characters of the first text string.
